(19) United States
(12) Patent Application Publication
(10) Pub. No.: US 2011/0253876 A1
(43) Pub. Date: Oct. 20, 2011

(54) SLAM IT SYSTEMS

(76) Inventors: David Odell, Solvang, CA (US); Debbie Odell, Solvang, CA (US)

(21) Appl. No.: 13/090,547

(22) Filed: Apr. 20, 2011

Related U.S. Application Data
(60) Provisional application No. 61/326,001, filed on Apr. 20, 2010.

(51) Int. Cl. F16M 13/00; B23P 11/00

(52) U.S. Cl. 248/530; 29/525.11

(57) ABSTRACT

Slam it systems is a ground-planted anchor member for securably supporting pole devices having various size widths. In a preferred embodiment, the anchor member comprises an upper portion comprising a pole receiver and a thumb screw, a middle portion comprising a slide shaft wherein a slide hammer is concentrically mounted thereto, and a bottom portion comprising a flanged spike. Concentrically disposed to a proximate end of the slide shaft is a keeper and concentrically disposed to a distal end of the slide shaft is a hammer disk plate. The device allows for a lowered center of gravity hammering means, increasing safety and efficiency in-use. A pole device, such as a tiki torch, umbrella, canopy, and the like may then be inserted into the pole receiver and securely held in place by the thumb screw.

### CROSS-REFERENCE TO RELATED APPLICATION

The present application is related to and claims priority from prior provisional application Ser. No. 61/326,001, filed Apr. 20, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of anchoring supports and more specifically relates to a ground-planted anchor member for supporting a pole device, such as a tiki torch, canopy, umbrella, or the like, and comprises a slide hammer to aid the user in pounding the anchor member into a ground surface.

### 2. DESCRIPTION OF THE RELATED ART

Many items may be stood up for use; some may require to be inserted into hard ground. Adverse ground conditions may prevent an item, such as an umbrella, from effectively penetrating through the ground. It may be difficult to keep a device firmly positioned in surfaces such as sand and gravel. This lack of stability might result in an inordinate amount of time being forfeited to repositioning the item, and possibly, not to be anchored effectively. There are also times when the item is lodged in the ground, but hazardous weather conditions such as wind, may displace the device, potentially causing damage to equipment and/or individuals in close proximity

A ground planted support stand may provide a user with a supplemental device to assist in anchoring an apparatus which may comprise a pole. For example, a beach-goer may desire an umbrella for providing shade while soaking in the summer sun. However, the loose consistency of sand may provide difficulties when attempting to stick the umbrella into the sand. If a strong wind passes, the umbrella may become dislodged and may cause injury if it were to fall on someone. Additionally, it may be frustrating for the beach-goer to enjoy the day if that person constantly has to re-plant the umbrella. Furthermore, when cold weather strikes and the earth becomes frozen and hard, it may be difficult, if not impossible, to penetrate the surface. Other surfaces such as rocky terrain or gravel may prove difficult to insert items into and a hammer may be used to drive a stake therein. Use of a hammer may be dangerous and inconvenient. A more effective support stand and inserting means is needed.

Various attempts have been made to solve the above-mentioned problems such as those found in U.S. Pat. and Pub. Nos. 2001/0035201 to Kuzmic; 6,899,187 to McCarthy; 6,328,046 to Doreste; 6,908,067 to Clasen; 2006/0241647 to Chen; and 5,396,916 to Boissonnault. This prior art is representative of ground-planted support stands. None of the above inventions and patents, taken either singly or in combination, is seen to describe the invention as claimed.

Ideally, a support stand should be easy to plant into various types of ground surfaces and should be suitable to receive support poles of different widths, and, yet, would operate reliably and be manufactured at a modest expense. Further, the support stand should be easy to remove from the ground after being planted, and should also be convenient to transport. Thus, a need exists for a slam it system to provide a ground-planted support stand for pole devices, such as umbrellas, flags, tiki torches, canopies, and more, and to avoid the above-mentioned problems.

### BRIEF SUMMARY OF THE INVENTION

In view of the foregoing disadvantages inherent in the known ground-planted support stand devices, the present invention provides a novel slam it system. The general purpose of the present invention, which will be described subsequently in greater detail, is to provide a ground-planted anchor member which may comprise a stabilized supporting means for pole devices of various widths and which may further comprise an integrated slide hammer for assisting a user in penetrating both hard and soft ground surfaces.

Slam it systems as described herein may comprise a ground-planted anchor member for securably supporting pole devices having various size widths. In a preferred embodiment, the anchor member comprises an upper portion comprising a pole receiver and a thumb screw, a middle portion comprising a slide shaft wherein a slide hammer is concentrically mounted thereto, and a bottom portion comprising a flanged spike. Concentrically disposed to a proximate end of the slide shaft is a keeper and concentrically disposed to a distal end of the slide shaft is preferably a hammer disk plate. The keeper and the hammer disk plate both may comprise a metallic (or other suitable material), round-shaped disk which may serve to slidably confine the slide hammer along the slide shaft (not top or bottom mounted, but confined within the parameters) to substantially prevent fingers being injured and to limit the stroke as desired. In this embodiment the slide hammer is located nearer the center of gravity so a more efficient driving force is realized. In use, a user may position the flanged spike onto a ground surface and forcefully strike the slide hammer down into the hammer disk plate until the anchor member is driven into the ground. A pole device, such as a tiki torch, umbrella, canopy, and the like may then be inserted into the pole receiver and securely held in place by the thumb screw. The inserted member may be removed by slidingly striking the slide hammer upwardly, releasing the item from the ground.

Slam it systems may be manufactured in various sizes and colors to appeal to the consumer market. In addition to providing a secure stabilizing anchor for pole devices, slam it systems may be used to tether the line of a boat. In such a manner, the present invention may provide a portable, ground-planted anchor on the shoreline to retain the position of a boat. This may be accomplished by inserting a hook device into the pole receiver which may be securely tightened and held in place by the thumb screw. The present invention obviates the need for a hammer or other tools, and thus is convenient in-use.

It should be appreciated that slam it systems provides a novel utility due to the incorporation of the integrated slide hammer feature. Consequently, slam it systems may be used in a large variety of ground surfaces. For example, slam it systems may be used with grass, gravel, sand, soil, and hard earth. The user may effectively drive the flanged spike of the anchor member into the ground surface, and then use the slide hammer to pound the anchor member fully into a frozen ground surface which otherwise would provide an extremely difficult, if not impossible, task for the user. The device is also safe in-use.

The present invention holds significant improvements and serves as a slam it system with integrated slide hammering means. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, slam it systems, constructed and operative according to the teachings of the present invention.

FIG. 1 is a perspective view illustrating slam it systems in an in-use condition according to an embodiment of the present invention.

FIG. 2 is a perspective view illustrating an anchor member comprising a slide hammer in an ‘up’ position according to an embodiment of the present invention of FIG. 1.

FIG. 3 is a perspective view illustrating the anchor member comprising the slide hammer in a ‘down’ position according to an embodiment of the present invention of FIG. 1.

FIG. 4 is a perspective view illustrating an exploded view of the anchor member according to an embodiment of the present invention of FIG. 1.

FIG. 5 is a flowchart illustrating a method of use according to a preferred embodiment of the slam it systems.

The various embodiments of the present invention will hereinafter be described in conjunction with the appended drawings, wherein like designations denote like elements.

### DETAILED DESCRIPTION

As discussed above, embodiments of the present invention relate to slam it systems and more particularly to a removably penetrable ground anchor member which may provide stabilized support for pole devices of various widths. The anchor member may comprise a slide hammer which may assist the user in penetrating ground surfaces of different consistencies. Slam it systems may serve as an improved versatile support tool for a variety of uses and applications.

Support stands have historically provided society with a means for holding a large variety of objects. Some support stands serve as a display device for presenting art, collections, or other memorabilia. Other support stands provide an upright support for objects which may not be vertically sustainable on its own. Regardless of the application, support stands serve a valuable function in modern society.

However, a substantial drawback of many support stands is the difficulty a user may experience when positioning the stand into an intended position or location. More specifically, a user may not be able to control the type of surface for which the stand is to be used. If a user wishes to pound a stand into the ground, this may prove to be a difficult and arduous task if the ground is hard or frozen. Further, if the ground surface is soft or loose, the support stand may tip over during use which may result in damage to the object being supported, or worse, may cause injury to surrounding persons. Therefore, a primary object of the present invention is to provide an improved, sturdy ground-plantable anchor member which may integrally provide a slide hammer for assisting the user in penetrating difficult ground surfaces, while also providing a means to support pole devices of various widths.

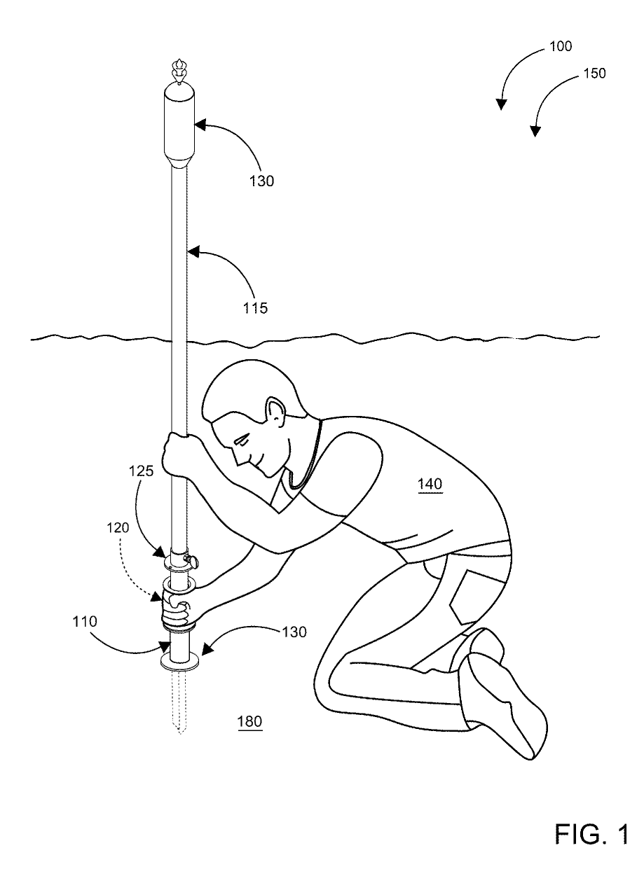

Referring to the drawings now by numerals of reference there is shown in FIG. 1, slam it systems 100 in an in-use condition 150 according to a preferred embodiment of the present invention.

Slam it systems 100 may generally comprise anchor member 110 having an upper portion, a middle portion, and a bottom portion. Anchor member 110 preferably comprises a cylindrically lance-shaped anchoring device which may be inserted into ground 180 by user 140. Once slam it systems 100 is planted into ground 180, anchor member 110 may support pole device 125 which is removably insertable into the upper portion of anchor member 110 by user 140. As shown in FIG. 1, pole device 115 may comprise tiki torch 145. The middle portion of slam it systems 100 comprises slide hammer 120 which may be concentrically mounted to anchor member 110. Slide hammer 120 may be slidably movable up and down anchor member 110 to assist user 140 in penetrating ground 180. Insertion may be accomplished via hammering motion as slide hammer 120 is moved with force between up and down positions (between keeper 125 and hammer disk plate 130.)

Preferably, slam it systems 100 comprises a durable, weather resistant ferrous material (preferably stainless steel or the like) so that it may withstand the outdoor elements. However it should be appreciated that in alternative embodiments of slam it systems 100, anchor member 110 may comprise a heavy-duty non-ferrous material, such as plastic which may generally be lighter in weight and easier to transport.

Pole device 115 which may be inserted into pole receiver 205 may comprise tiki torch 145, flag 474, canopy 478, or umbrella 482. Furthermore, pole device 115 may further comprise other types of devices comprising a pole such as a volleyball net, camping tent, and the like. It should also be noted that ground 180 may comprise different types of subterranean surfaces such as sand, grass, gravel, or other compacted surface which otherwise may be difficult to insert a ground planted support device.

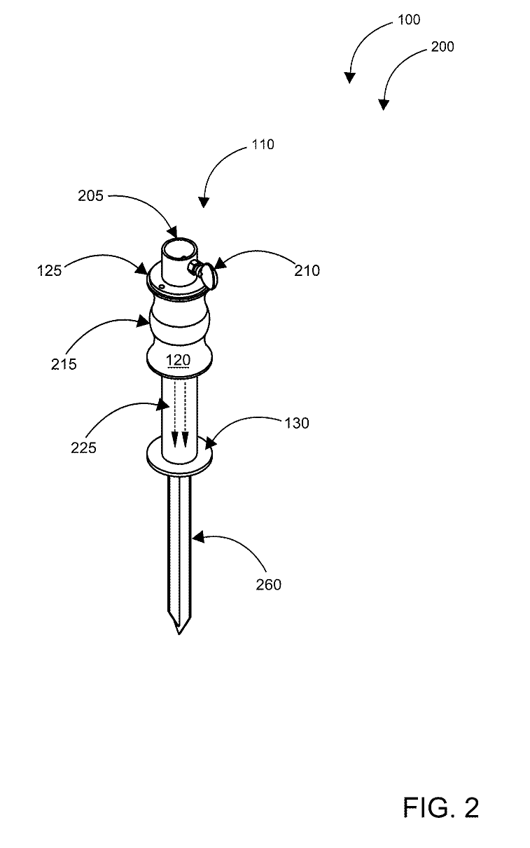

In now referring to FIG. 2, illustrating a perspective view of slam it systems 100 comprising slide hammer 120 in an up position 200 according to an embodiment of the present invention of FIG. 1.

The upper portion of anchor member 110 comprises pole receiver 205 for receiving and securing pole device 115. Further, the upper portion of slam it systems 100 may comprise thumb screw 210 for securing pole device 115 in a ‘received condition.’ Once pole device 115 is inserted into pole receiver 205, user 140 may securably retain pole device 115 in place by tightening thumb screw 210 by turning it clockwise (and released by turning counter-clock-wise.) It should be appreciated that pole device 115 may comprise different size widths such that various types of pole devices 115 may be securely held in place by slam it systems 100 by turning (tightening) thumb screw 210 the appropriate distance.

In continuing to refer to FIG. 2, the middle portion of anchor member 110 may comprise slide shaft 225 having a proximate end and a distal end. Slide shaft 225 may generally comprise a cylindrical metallic tube which may connect the upper portion of anchor member 110 to the bottom portion of anchor member 110. Concentrically disposed on the proximate end of slide shaft 225 is keeper 125. Additionally, concentrically disposed on the distal end of slide shaft 225 is hammer disk plate 130. Keeper 125 may generally comprise a metallic disk-shaped member which may serve to restrict movement of slide hammer 120 when in an up position 200. Furthermore, keeper 125 may provide a separator between slide shaft 225 and pole receiver 205. In this way the present invention enables slide hammer 120 to be safe in-use and located closer to the center of gravity of anchor member 110 providing better control and efficiency when driving into ground 180.

In still referring to FIG. 2, the bottom portion of anchor member 110 may comprise flanged spike 260 (shown in an inserted condition referenced by dotted lines in FIG. 1.) Preferably, flanged spike 260 comprises a hard metal material having a sharp tip at the bottom and may be shaped like a stake. In such a manner, upon an initial driving force by user 140, flanged spike 260 may begin to penetrate ground 180 comprising a hard surface. Flanges help to prevent flanged spike 260 from turning and provide a greater gripping capacity due to the increased surface contact area with ground 180. Thereafter, user 140 may utilize slide hammer 120 to continue to drive flanged spike 260 deeper into ground 180. Preferably, user 140 shall continue to strike slide hammer 120 into hammer disk plate 130 until a bottom side of hammer disk plate 130 is touching ground 180.

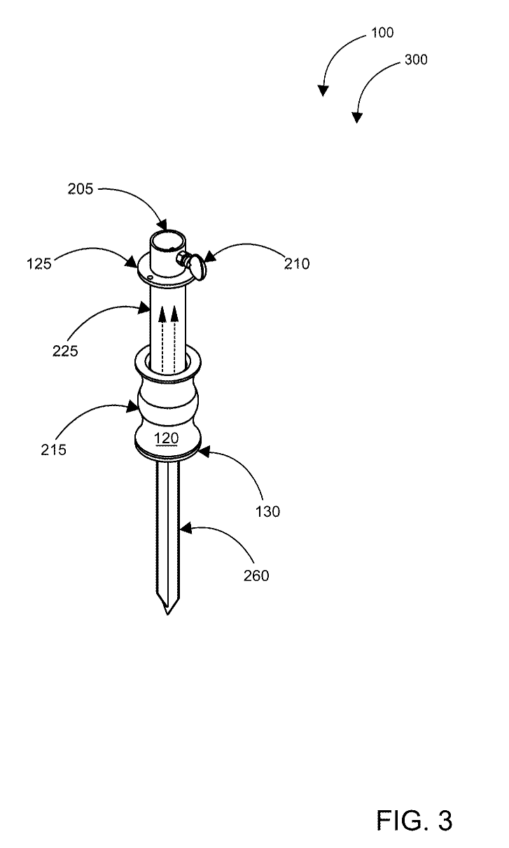

Referring now to FIG. 3, illustrating a perspective view of slam it systems 100 comprising slide hammer 120 in a down position 300 according to an embodiment of the present invention of FIG. 1.

Hammer disk plate 130 may be concentrically disposed on the distal end of slide shaft 225 and may comprise a metallic disk-shaped member similar to keeper 115. Hammer disk plate 130 may serve to restrict down swing of slide hammer 120 when in a down position 300. Hammer disk plate 130 serves as a force communicator wherein the driving action is directed to the tip as it is driven into ground 180. Furthermore, keeper 125 may provide a separator between slide shaft 225 and flanged spike 260 of bottom portion.

As shown in FIG. 3, according to a preferred embodiment of slam it systems 100, slide hammer 120 may be concentrically mounted around slide shaft 225. Slide hammer 120 may generally comprise a hard, metallic material. As shown in FIGS. 2 and 3, slide hammer 120 is concentrically mounted around anchor member 110 such that it may be slidably moveable up and down slide shaft 225 between up position 200 and down position 300. It should be noted that slide hammer 120 is spatially confined by keeper 125 when slide hammer 120 is in an up condition 200 and by hammer disk plate 130 when slide hammer 120 is in a down position 300.

Preferably, slide hammer 120 comprises hand grip 215. It should be appreciated that hand grip 215 may comprise a dipped recess along the outside of slide hammer 120 and is designed to be contoured to the shape of either a left hand or a right hand of user 140 (using grippable indents to maximize grip and surface-to-hand contact.) Consequently, slide hammer 120 may be comfortably gripped during an in-use condition 150. Therefore, regardless of type of surface of ground 180, user 140 may easily and effectively strike slide hammer 120 continuously into hammer disk plate 130 thereby driving anchor member 110 deeper into ground 180.

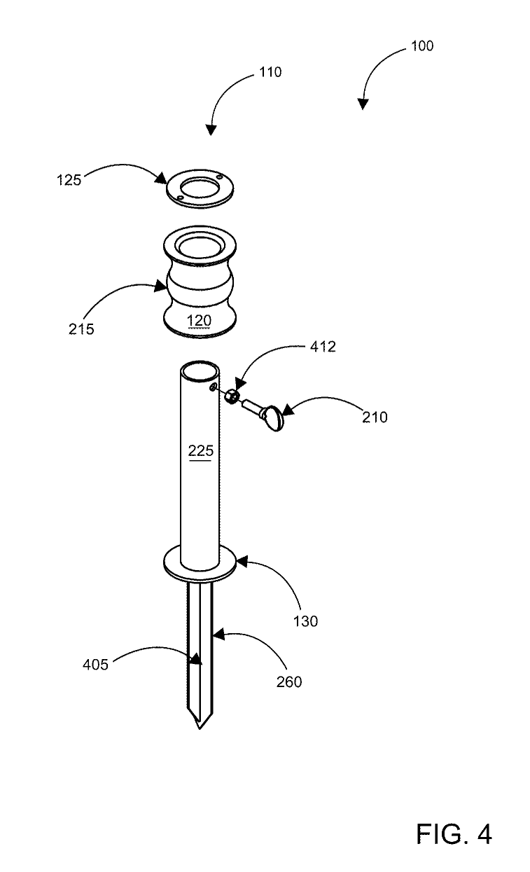

FIG. 4 shows an exploded view of slam it systems 100 according to a preferred embodiment of the present invention. As shown, slam it systems 100 may comprise anchor member 110 wherein anchor member 110 comprises slide shaft 225 having an upper portion, a middle portion, and a bottom portion. From top to bottom, concentrically disposed to a proximate portion of slide shaft 225 is keeper 125 and concentrically disposed to distal portion of slide shaft 225 is hammer disk plate 130. Concentrically mounted to slide shaft 225 and in between keeper 125 and hammer disk plate 130 is slide hammer 120. Situated on the upper portion of anchor member 110 may be pole receiver 205 comprising thumb screw 210 and screw nut 412 to secure pole device 115 when inserted into pole receiver 205. It should be noted that keeper 125 may serve to separate pole receiver 205 from slide shaft 225. The bottom portion of anchor member 110 may comprise flanged spike 260. It should be noted that hammer disk plate 130 may serve to secure flanged spike 260 to slide shaft 225 in addition to providing a striking surface for slide hammer 120.

The present invention may comprise anchoring member 110 for supporting pole device 115, such as tiki torch 145, as shown in FIG. 1, and may comprise a cylindrically lance-shaped anchoring member comprising light-weight, durable ferrous material having an upper portion comprising thumb screw 210 and screw nut 412 for tightening anchor member 110 to pole device 115, a middle portion comprising keeper 125 concentrically disposed to proximate end of slide shaft 225, hammer disk plate 130 concentrically disposed to distal end of slide shaft 225, and slide hammer 120. Slide hammer 120 comprises hand grip 215; wherein slide hammer 120 is used to insert and/or remove anchor member 110 into/from ground 180. Bottom portion comprises flanged spike 260 wherein flanged spike 260 comprises flutes 405 for increasing a surface area of contact between flanged spike 260 and a subterranean volume of ground 180. When slam it systems 100 comprising anchor member 110 is inserted into ground 180, slam it systems 100 may provide a secure and stabilized anchor for pole device 115.

It should be appreciated that anchor member 110 may comprise different sizes, dimensions, and colors to appeal to the consumer market at large. Further, various types of indicia such as logos, designs, trademarks, and other writing may be inscribed into a surface of anchor member 110 or slide hammer 120 for commercial, marketing, or personal identification use.

In an alternative embodiment of the present invention, slam it systems 100 may be used to tether a boat line and serve as a portable anchor, as mentioned above. Preferably, a hook device comprising a pole may be inserted into pole receiver 205 once anchor member 110 is inserted into ground 180. A line from a boat may then be tied onto the hook, providing an anchor for a boat.

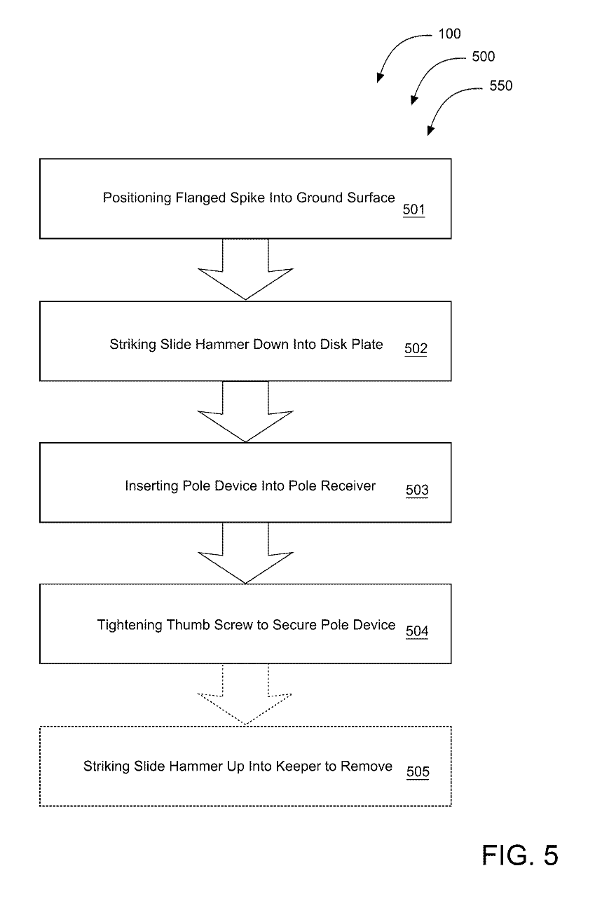

FIG. 5 shows flowchart 550 illustrating method of use 500 of slam it systems 100 according to a preferred embodiment of the present invention of FIGS. 1-4. Method of use 500 may comprise the steps of: step one 501 positioning flanged spike 260 of anchor member 110 onto a suitable location of ground 180, step two 502 striking slide hammer 120 down into hammer disk plate 130, step three 503 inserting pole device 115 into pole receiver 205, step four 504 tightening thumb screw 210 to secure pole device 115, and step five 505 sliding strike hammer 120 up into keeper 125 to remove anchor member 110 from ground 180.

It should be noted that step four 505 is an optional step and may not be implemented in all cases as user 140 may desire to keep anchor member 110 in ground 180 for an indefinite period of time. Optional steps of method 500 are illustrated using dotted lines in FIG. 5 so as to distinguish them from the other steps of method 500.

Slam it systems 100 may be sold as a kit with various sizes and may include items for which the present invention may serve to secure. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An anchoring apparatus for supporting a pole device comprising:
a cylindrically lance-shaped anchoring member having an upper portion, a middle portion, and a bottom portion;
a keeper;
a slide hammer;
a hammer disk plate;
wherein said upper portion comprises a pole receiver for receiving said pole device;
wherein said middle portion comprises a proximate end and a distal end;
wherein said bottom portion comprises a flanged spike;
wherein said keeper is concentrically disposed on said proximate end of said upper portion;
wherein said slide hammer is able to move concentrically along said middle portion;
wherein said hammer disk plate is concentrically mounted on said distal end of said middle portion adjacent said flanged spike;
wherein a stroke of said slide hammer is slidably confined along said middle portion by said keeper and said hammer disk plate such that said slide hammer is located close to a center of gravity nearest a ground surface for efficient driving force to be communicated; and
wherein said anchoring apparatus is removably insertable into said ground surface thereby providing an anchor.

2. The anchoring apparatus of claim 1 wherein said upper portion comprises a thumb screw for tightening said anchoring apparatus to said pole device.

3. The anchoring apparatus of claim 1 wherein said cylindrically lance-shaped anchoring member comprises a light-weight, durable ferrous material.

4. The anchoring apparatus of claim 1 wherein said slide hammer is usable to insert and/or remove said anchoring apparatus into/from said ground surface.

5. The anchoring apparatus of claim 1 wherein said slide hammer comprises a hand grip with grippable indents.

6. The anchoring apparatus of claim 1 wherein said upper portion comprises a hook for securing a line thereto.

7. The anchoring apparatus of claim 6 wherein said line is connectable to a boat.

8. The anchoring apparatus of claim 1 wherein said pole device comprises a Tiki torch.

9. The anchoring apparatus of claim 1 wherein said pole device comprises an umbrella.

10. The anchoring apparatus of claim 1 wherein said pole device comprises a sporting device.

11. The anchoring apparatus of claim 10 wherein said sporting device comprises a net.

12. The anchoring apparatus of claim 1 wherein said pole device comprises a flag.

13. The anchoring apparatus of claim 1 wherein said pole device comprises a canopy.

14. The anchoring apparatus of claim 1 wherein said ground surface comprises sand.

15. The anchoring apparatus of claim 1 wherein said ground surface comprises gravel.

16. The anchoring apparatus of claim 1 wherein said ground surface comprises grass.

17. The anchoring apparatus of claim 1 wherein said ground surface comprises a compacted surface.

18. The anchoring apparatus of claim 1 wherein said flanged spike comprises flutes for increasing a surface area of contact between said flanged spike and a subterranean volume of ground.

19. An anchoring apparatus for supporting a pole device comprising:
a cylindrically lance-shaped anchoring member comprising light-weight, durable ferrous material having an upper portion comprising a thumb screw wherein said thumb screw comprises a screw nut for tightening said anchoring apparatus to said pole device, a middle portion, and a bottom portion;
a keeper;
a slide hammer comprising a hand grip wherein said slide hammer is usable to insert and/or remove said anchoring apparatus into/from said ground surface;
a hammer disk plate;
wherein said upper portion comprises a pole receiver for receiving said pole device;
wherein said middle portion comprises a proximate end and a distal end;
wherein said bottom portion comprises a flanged spike comprising flutes for increasing a surface area of contact between said flanged spike and a subterranean volume of ground;
wherein said keeper is concentrically disposed on said proximate end of said upper portion;
wherein said slide hammer is able to move concentrically along said middle portion;
wherein said hammer disk plate is concentrically mounted on said distal end of said middle portion adjacent said flanged spike;
wherein a stroke of said slide hammer is slidably confined along said middle portion by said keeper and said hammer disk plate; and
wherein said anchoring apparatus is removably insertable into a ground surface thereby providing an anchor.

20. A method of using an anchoring apparatus comprising the steps of:
positioning a flanged spike of said anchoring apparatus onto a ground surface;
forcefully striking a sliding hammer down into a hammer disk plate until said anchoring apparatus is non-movably inserted into said ground surface;
inserting a pole device into a pole receiver of said anchoring apparatus; and
tightening a thumb screw to secure said pole device within said pole receiver of said anchoring apparatus.
